(19) United States
(12) Patent Application Publication
(10) Pub. No.: US 2009/0172950 A1
(43) Pub. Date: Jul. 9, 2009

(54) ATTACHABLE HAND HELD PRUNING SAW

(76) Inventor: Scott Jenkinson, Davisburg, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/262,685

(22) Filed: Oct. 31, 2008

Related U.S. Application Data
(63) Continuation of application No. 61/020,050, filed on Jan. 9, 2008.

(51) Int. Cl. B26B 1/02

(52) U.S. Cl. 30/155

(57) ABSTRACT

A hand-held pruning saw having an elongated body incorporating a blade retractably secured thereto. The body exhibits a longitudinally extending surface, within which is defined a seating depression for receiving in aligning and adhering fashion an extending rod. The body further exhibits a pair of crosswise extending slots for receiving first and second straps for securing about the rod and affixing the body thereto. The straps each include an end-mounted ring and further exhibit hook and loop portions on one surface and a rubberized and slip-resistant surface on an opposite face, in order to both secure about the rod and to prevent slippage of the rod relative to straps.

### CROSS-REFERENCE TO RELATED APPLICATIONS

This Application is a Non-Prov of Prov (35 USC 119(e)) application 61/020,050 filed on Jan. 9, 2008 entitled Attachable Hand Held Pruning Saw.

### FIELD OF THE INVENTION

The present invention relates to a pruning saw used such as by hunters when preparing their tree stands and rifle blinds out in the woods. More particularly, the present invention discloses a hand held pruning saw that includes integrated attachment straps which are used to strap the pruning saw onto an existing pole or branch. Once secured, the pruning saw can be used to cut hard to reach limbs in trees. The benefit of this design is that it is very compact, and can be stored easily in a hunter's back pack. Because the saw's attachment features, no special poles or extensions are required, rather, it accommodates any size branch or pole, and such as which is typically found on site in the wild.

The hand-held pruning saw is produced in either a plastic/rubberized version exhibiting a molded handle or, alternatively, a wood handle variant. In either instance, the design of the handle is such that the straps, having been engaged to lash the saw to the branch, permit the blade to be opened or closed without interfering with the straps.

### BACKGROUND OF THE INVENTION

Pruning saws are typically known in the art and which can include such features as light weight and ease of storage, such as being carried within a back pack when hiking thru the woods. When preparing their tree stand or rifle blinds, hunters use these saws to trim branches around their stand and to clear shooting lanes. However many times there are branches that are not reachable from the ground or the tree stand. These limbs are very difficult to cut and often require a lot of work to get them cut down.

There exists a need in the art for a portable saw that can access hard to reach (e.g. typically elevated) areas. Today there are pruning saws that have extension poles used for cutting limbs high above the ground. However, these devices are too heavy and too bulky to take out in the middle of the woods where a hunter needs to use them the most. It is further a given that branches lying on the ground in the woods can be used as an extension tool for a hand held pruning saws, and assuming the same is easily attachable to the pruning saw.

Examples of prior art include the folding handsaw accessory of Shellnutt U.S. Pat. No. 5,860,216 in which an elongated body exhibits a longitudinal passageway from one end thereof for receiving a folding blade. Skyba U.S. Pat. No. 4,716,653 teaches a tree saw with extension attachment and by which a pair of swingable rings are mounted to a back of the saw handle. A fulcrum is secured to the handle back surface intermediate the rings, with the limb being inserted through the rings, over the fulcrum, then being bent into a concave shape.

### SUMMARY OF THE INVENTION

The present invention discloses a portable and hand held pruning saw with a combination handle/body from which is pivotally extended an associated blade portion (such as further exhibiting serrated teeth). The body is configured to exhibit an elongate and arcuate recess in a longitudinal extending direction, and such that a generally rounded and elongate shaped branch will substantially seat against and within the associated side of the body.

A pair of slots are defined in recessed and crosswise extending locations of tie body, such as which receive a pair of flattened mounting straps ins such a fashion that the body can be lashed to a branch or pole without interfering with the opening and closing of the saw blade. The hand-held pruning saw is produced in either a plastic/rubberized version exhibiting a molded handle or, alternatively, a wood handle variant. In either instance, the design of the handle is such that the straps, having been engaged to lash the saw to the branch, permit the blade to be opened or closed without interfering with the straps.

Once secured in tie fashion described above, the pruning saw can be used to cut hard to reach limbs in trees and depending upon the length and rigidity of the supporting branch or pole to which it is fastened. The benefit of the design includes its compactness and ease of storage, such as within a hunter's back pack. Furthermore, and because of the pruning saw attachment features, no special poles or extensions are required; rather the device accommodates any size branch or pole, and such as which is typically found on site in the wild.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of the pruning saw according to a first preferred embodiment of the present invention and illustrating the blade illustrated in phantom in a closed position;

FIG. 2 is a perspective view illustration of the pruning saw of FIG. 1 and illustrating the blade in an opened position;

FIG. 3 is a rotated perspective view of the pruning saw in FIG. 2, and further illustrating the underside and blade receiving cavity configuration relative to the positioning and arrangement of the strap receiving and crosswise extending slots;

FIG. 4 is a side plan environmental view of the pruning saw in the configuration of FIG. 1 mounted to an elongated branch or pole;

FIG. 5 is a rotated perspective of FIG. 4;

FIG. 6 is a further rotated perspective and showing the blade in an opened rotated position;

FIG. 7 is an enlarged illustration similar to that shown in FIG. 2;

FIG. 8 is a further modified illustration in perspective and illustrating in phantom an in-molded rubberized insert for providing ergonomic comfort when holding the pruning saw as well as assisting in holding the pole/branch in place when strapped/engaged by the saw;

FIG. 9 is a further rotated use illustration in perspective, similar to that shown in FIG. 6 and exhibiting the blade in an opened position;

FIG. 10 is a top plan view of the pruning saw body of FIG. 1;

FIG. 11 is a cutaway view, taken along line 11-11 of FIG. 10, and further showing a selected and assembleable half of the body;

FIG. 12 is a first top plan view of a selected hook and loop (Velero) strap for engaging through the crosswise slot defined in the handle body;

FIG. 13 is a rotated bottom plan view of the hook and loop strap shown in FIG. 12 and further illustrating a rubber material placed thereon;

FIG. 14 is a perspective view of the pruning saw according to a second preferred embodiment with a wood handle and further showing the saw in an opened position and lashed to a pole or rod;

FIG. 15 is a rotated perspective view of the pruning saw of FIG. 14;

FIG. 16 is a rear end view of the pruning saw of FIG. 14;

FIG. 17 is a top plan view of the pruning saw body of FIG. 14;

FIG. 18 is a cutaway view, taken along line 18-18 of FIG. 17, and further showing a selected and assembleable half of the body;

FIG. 19 is a side plan cutaway view of the pruning saw mounted to a branch, with a selected assembleable half of the body removed, and which further illustrates the blade in a rotated and closed position;

FIG. 20 is a closed perspective of the pruning saw of FIG. 14 and with the blade illustrated in the closed position;

FIG. 21 is an illustration similar to FIG. 14 of the pruning saw in an open position and disengaged from a tree branch or rod; and

FIG. 22 is a rotated and underside looking perspective blade receiving cavity configuration relative to the positioning and arrangement of the strap receiving and crosswise extending slots.

### DETAILED DESCRIPTION OF THE PREFERRED EMBODIMENTS

Referring first to FIGS. 1-11, a series of perspective, plan and environmental views are shown of a hand-held pruning saw 10 according to a first embodiment and exhibiting a plastic or rubberized configuration. The saw 10 is selectively engageable along a top and lengthwise extending surface of its body, see as generally shown at 11, in a contoured receiving and abutting fashion to an arcuate surface of a conventional rod or pole, see at 2.

As previously described, the invention includes integrated attachment straps, such as illustrated in phantom at 12 and 14 throughout the present illustrations, which are used to engage through an associated pair of crosswise extending slots, see at 16 and 18, defined in crosswise fashion through the body associated with the pruning saw and in order to strap the pruning saw 10 onto an existing pole or branch 2. The slots 16 and 18 are positioned in a recessed and uppermost position relative to an underside defined and substantially lengthwise extending blade receiving slot 20, such that opening and closing of an associated (typically serrated) blade 22, mounted in pivotal fashion relative to the body at a pivot point 24. In this fashion, rotating translation of the blade 22 in directions both seating within the receiving slot 20 occurs without interfering with the crosswise defined slots 16 and 18 and associated straps 12 and 14. As further shown, the configuration of the lengthwise receiving slot is such that it overlaps and extends along a top edge of the body 11 proximate and through the crosswise pivot mounting point 24 established between the blade 22 and the handle body, see again at 11, this again in order to provide adequate clearance so that the blade 22 can rotate between its opened and closed positions.

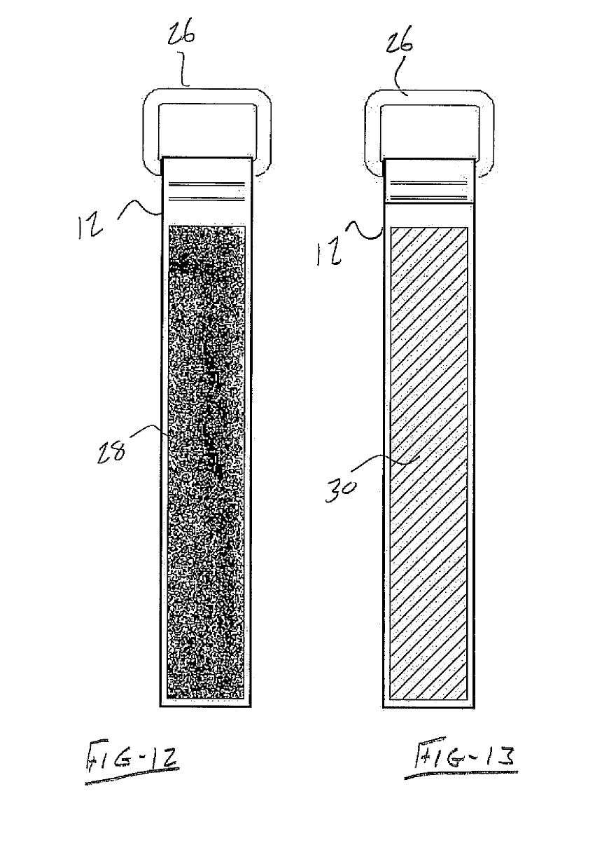

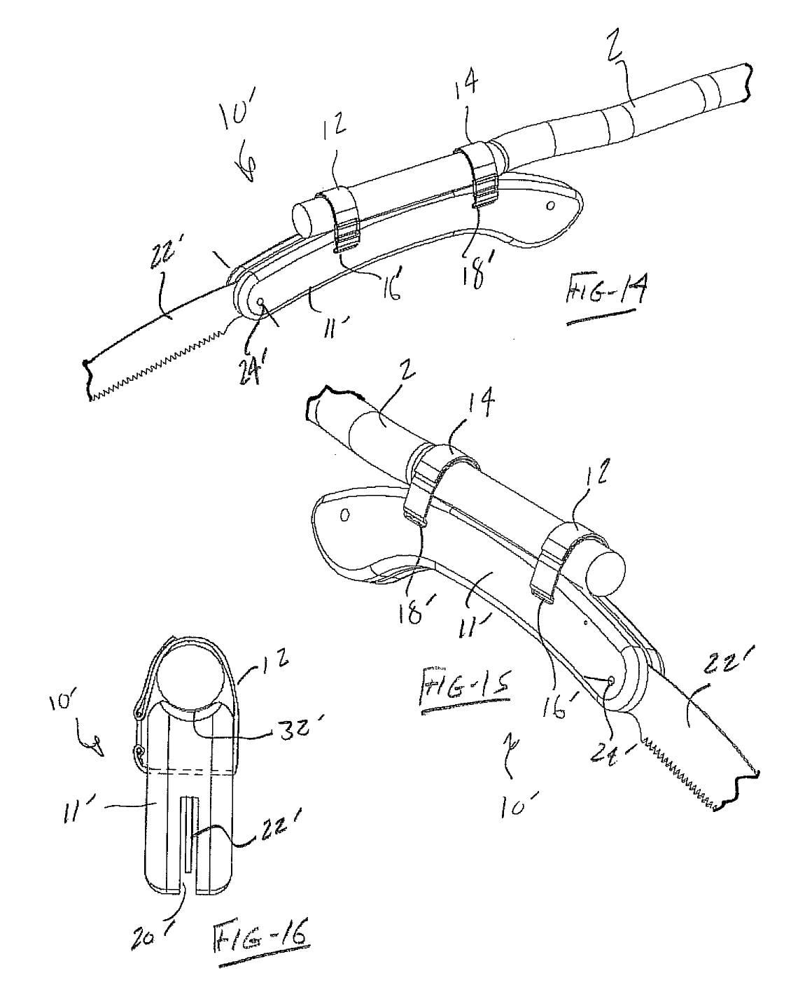

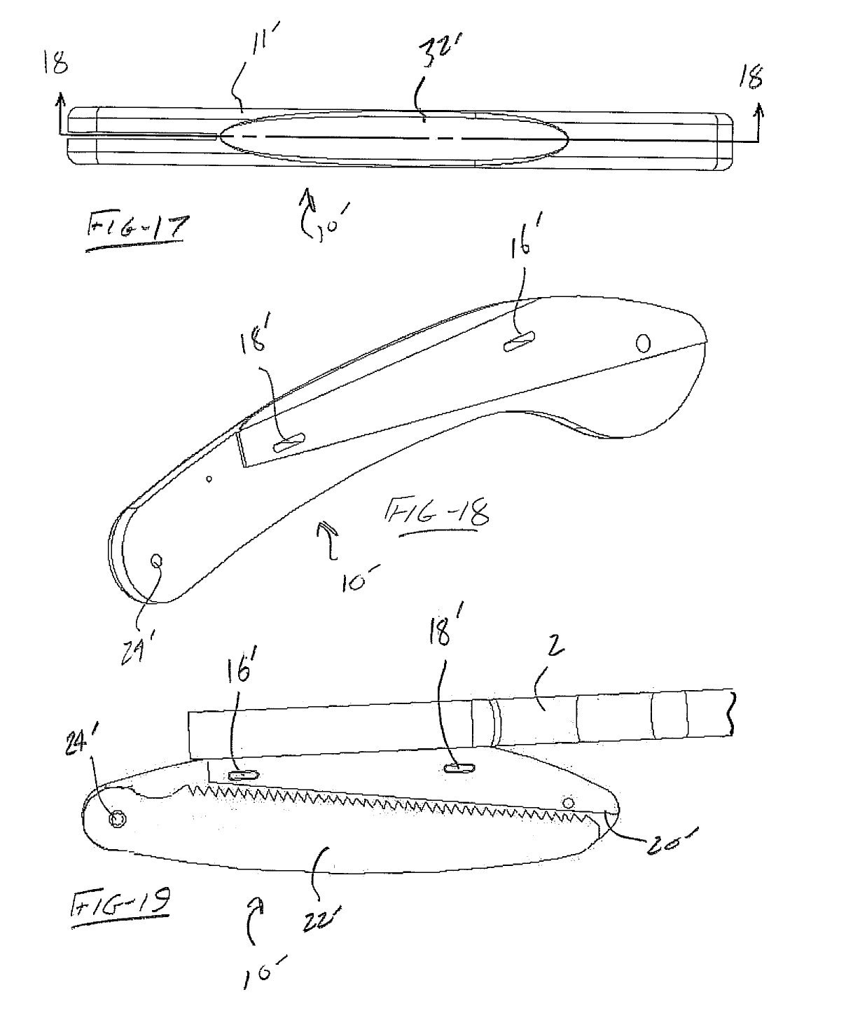

The straps 12 and 14 can include such as elastic type cords, or other forms of either natural or synthetic cordage exhibiting buckle and catch, cleat or other known type of fastening structure, and in order to prevent the straps from inadvertently loosening or coming undone. As further shown in FIGS. 12 and 13, selected strap 12 exhibits an elongated body and includes an upper end mounted ring 26, with FIG. 12 illustrating a top view further exhibiting a single sided hook and loop material 28 (e.g. again such as Velcro), and which can serve as the main strap material or, alternatively, as an add on to a more durable strap material. As further shown in FIG. 13, a corresponding bottom view of the strap exhibits a rubber material 30, this seating against the rod or stick 2, and establishing a slip-retardant layer for preventing the same from moving or slipping once tightened. The hook and loop facing surface 28 is employed to secure the strap in place once drawn down tight against the branch/pole.

Once secured, the pruning saw 10 can be used to cut hard to reach limbs in trees. As also previously described, the benefit of this design is that it is very compact, and can be stored easily in a hunter's back pack. Furthermore, and because of the saw's attachment features, no special poles or extensions are required, rather, it accommodates any size branch or pole, and such as which is typically found on site in the wild.

As illustrated at 32 and best shown in FIG. 1, a top extending and recessed (or interiorly grooved) surface (such as concave or similarly recess arcuate) is defined within the body 11, substantially along its length, and so that the opposing surface of the rod, branch or pole 2 is nestingly engaged within the recessed surface 32. As shown, the crosswise extending and strap mounting slots 16 and 18 are positioned at spaced apart and interiorly defined locations along the lengthwise extending body, approximate the arcuate/concave recess, and at locations above the inner seating edge of the elongate and blade receiving slot 20 defined within the handle body 11. The configuration of the recessed arcuate surface/groove 32 is further such that, in addition to the open end design of the straps, any size or shape of branch can be utilized.

The pruning saw, as known, can exhibit any suitable blade edge configuration (such as plural sawtooth edge associated with the blade 22), and such as which in the preferred embodiment will allow the user to effectively clear brush and other obstructions, such as normally associated with constructing a hunting blind or the like. Also, and as is contemplated in a preferred application, the blade 22 is pivoted between opened and closed positions relative to a handle body 11 (such as about pivot pin location 24) in a fashion typically known and which employs such as a button, tab or catch for selectively locking the blade in either the opened or closed position.

The body 11 can be constructed of a durable and resilient material, such as a heavy duty plastic, steel or other suitable material with a generally elongate and slender profile for concealing the blade 22 in its closed position. The body 11 is further configured so that its elongate and arcuate recess or depression, see again as defined by recessed receiving slot 20, extends in a longitudinal extending direction, and such that a generally rounded and elongate shaped branch, again at 2, will substantially seat against and within the associated side of the body.

FIG. 2 is a perspective view illustration of the pruning saw 10 of FIG. 1 and illustrating the blade 22 in an open rotated position. Again shown in enhanced detail are the features of the upper arcuate recessed groove or surface for seating along an opposing edge of a pole, as well as the arrangement and location of the crosswise extending slots 16 and 18 through which are insertably mounted the straps 12 and 14. FIG. 7 is an enlarged illustration similar to that shown in FIG. 2.

FIG. 3 is a rotated perspective view of the pruning saw 10 in FIG. 2, and further illustrating the underside and blade receiving cavity configuration relative to the positioning and arrangement of the strap receiving and crosswise extending slots 16 and 18. Also illustrated is the clearance cut defined in the open underside of the body 11, and which receives the blade 22 when rotated closed.

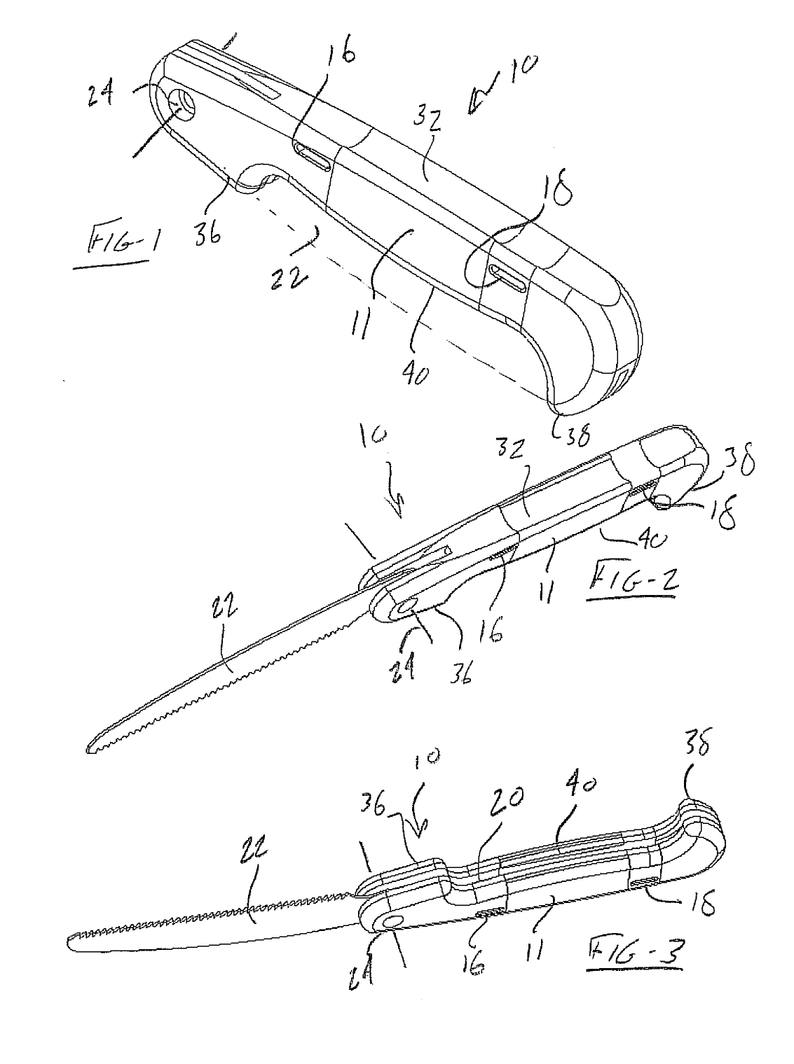

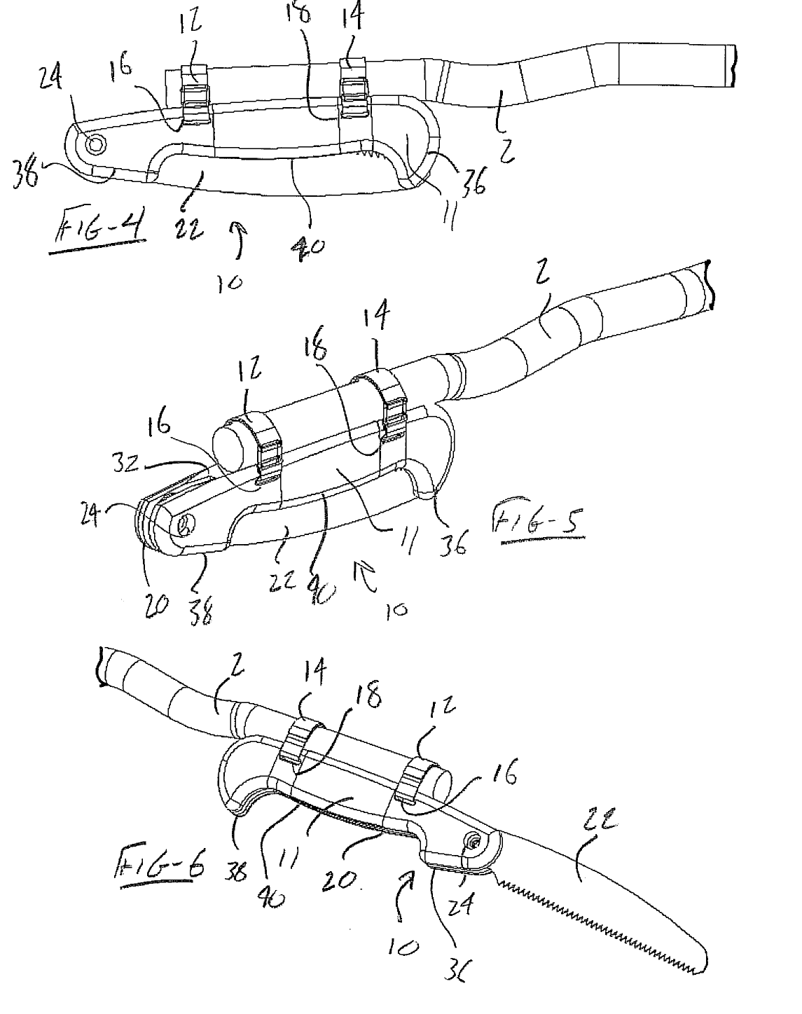

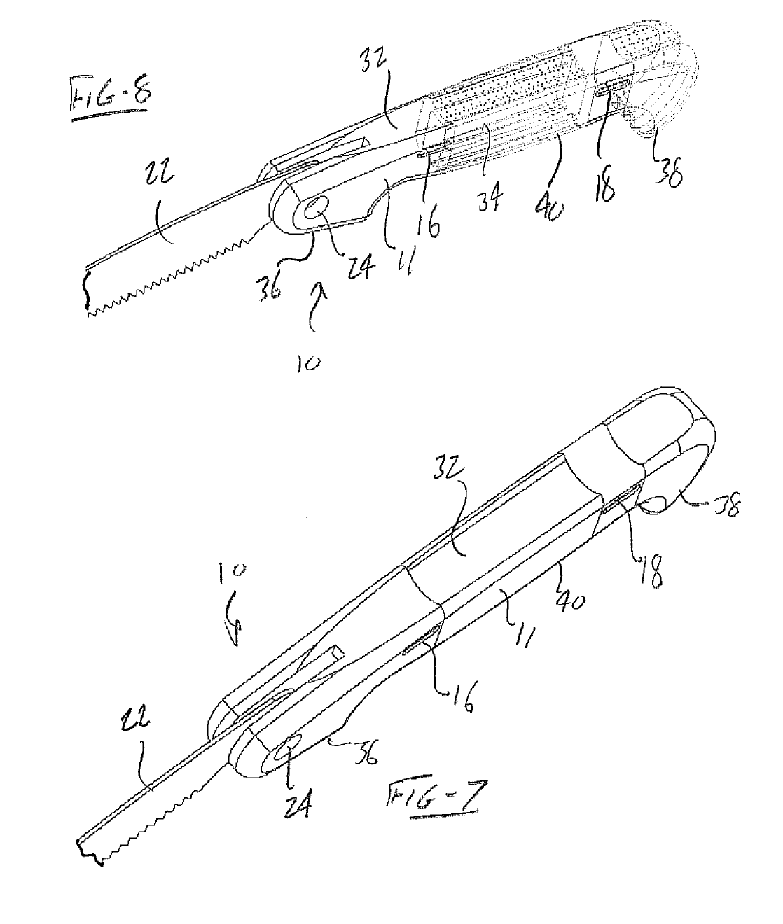

FIG. 4 is a side plan environmental view of the pruning saw 10, in the configuration of FIG. 1 with the blade 22 rotated closed, and with the body 11 mounted to an elongated branch or pole 2 via the straps 12 and 14 extending through the slots 16 and 18 in a non-interfering fashion relative to the underside positioned clearance cut (this again defining an inner seating and linear extending surface within the body interior which is positioned below the mounting locations of the crosswise straps 12 and 14 and again so that the blade 22 can be opened and closed while the saw 10 is secured to the branch or rod 2. Reference is also made to the opened (FIG. 6) and closed (FIG. 5) blade positions.

Referring now to FIG. 8, a further modified illustration is shown in perspective and in phantom of an in-molded rubberized insert, see at 34, enclosed within the body 11, between the crosswise slots 12 and 14, and in supporting fashion for cushioning the blade 22 when rotated to a closed position. The insert 34 both provides protection to the serrated edge of the blade 22 when rotated closed, as well as providing a degree of ergonomic comfort when holding the saw, as well as when the saw is strapped to the pole. The molded rubberized insert complements a standard handle material construction including any of plastic, wood or other suitable material.

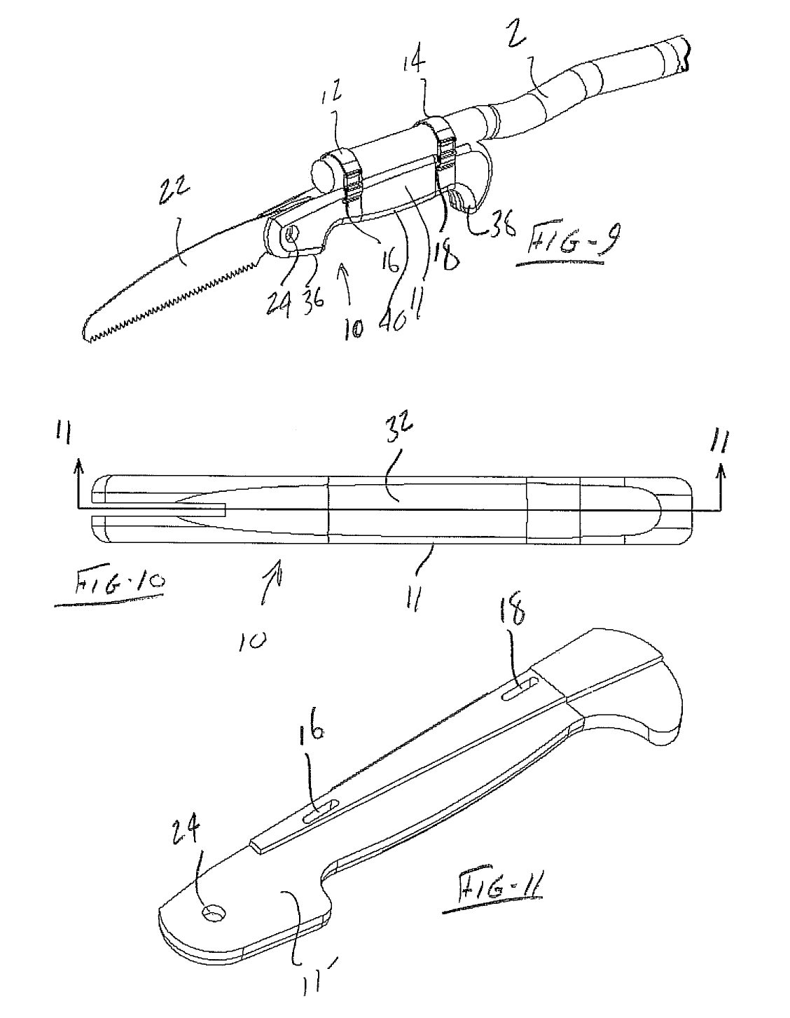

FIG. 9 is a further rotated use illustration in perspective, similar to that shown in FIG. 6 and exhibiting the blade 22 in an opened and extended position. FIG. 10 is a top plan view of the pruning saw body 11 of FIG. 1, whereas FIG. 11 is a cutaway view, taken along line 11-11 of FIG. 10, and further showing a selected and assembleable half 11′ of the body. The body can be constructed, among other potential designs, as first and second halves which are secured together by any of mechanical fasteners, adhesives or, in the instance of a plasticized construction, by sonic welding the opposing edges of the halves to create a unitary body structure (this usually occurring after the blade 22 and its associated components are first pivotally secured at its rotatable location relative to the open, lengthwise extending and aperture communicating location. As further shown throughout each of the illustrations in FIGS. 1-11, the underside and blade receiving surface of the body 11 can further include a surface profile exhibiting forward 36 and rearward 38 projecting ends, between which extends a recessed intermediate location 40, this establishing a desired underside profile for receiving the blade 22 when seated in the closed position (see again FIG. 1)

Referring now to FIGS. 14-22, a series of perspective, planar and cutaway views are shown of the pruning saw according to a second preferred embodiment, at 10′, and such as which may employ a wood handle. The embodiment of FIGS. 14-22 is functionally similar in all material respects to that shown in FIGS. 1-11, and accordingly each feature previously recited is repeated for this variant.

Namely pruning saw 10′ exhibits first and second crosswise extending slots 16′ and 18′ for seating therein associated straps (again at 12 and 14 in FIGS. 12 and 13). Underside and lengthwise extending recess 20′ seats rotatable blade 22′ about a mounting pivot point 24′ and so that, upon rotating the blade to the closed position, the serrated edge of the blade 22′ seats approximate an inner clearance cut edge (see as shown at FIG. 19) of the recess 20′. Concave or arcuate recess is again shown at 32′, this extending along the top surface of the saw body 11′ (see in particular FIG. 17) and so that the body 11′ can be seated against an opposing surface of the rod 2 (as best shown in each of FIGS. 14-16). The top and bottom exterior profiles of the handle/body 11′ are otherwise slightly different from that illustrated in reference to the body 11 in FIG. 1 and exhibit a generally more rounded and even profile in comparison.

Referring again to FIG. 14, further shown is the saw 22′ in an opened position and with the body 11′ lashed to a pole or rod 2. The straps 12 and 14 are mounted through crosswise extending slots 16′ and 18′, in a similar fashion as described in reference to the first preferred embodiment 10, and so that the opening and closing of the blade 22′ does not interfere with the straps 12 and 14. The upper side concave groove (recess), although not shown, enables the opposing surface of the rod 2 to be adhered in a seating fashion and, by further virtue of the rubberized coating applied to the straps 12 and 14 (see again FIG. 13) assists in preventing undesirable slippage once the hook and loop fasteners are applied.

FIG. 15 is a rotated perspective view of the pruning saw of FIG. 14, whereas FIG. 16 is a rear end view of the pruning saw of FIG. 14 and better illustrating the manner in which forward located strap 12 is seated and secured in a fashion so that it will not interfere with the blade 22′ when seated against the interiorly defined (and below positioned) clearance cut edge extending along the linear recessed surface of the body 11′ (see also FIG. 19).

FIG. 17 is a top plan view of the pruning saw body of FIG. 14, whereas FIG. 18 is a cutaway view, taken along line 18-18 of FIG. 17, and further showing a selected and assembleable half of the body which can again be provided as first and second halves which are assembled by fasteners, adhesives or the like (not shown).

FIG. 19 is a side plan cutaway view of the pruning saw mounted to a branch, with a selected assembleable half of the body removed, and which further illustrates the blade 22′ in a rotated and closed position aligning with the clearance cut surface of the interior receiving slot 10′ defined along the body. FIG. 19 also best shows the positioning of the crosswise strap mounting slots 16′ and 18′ above the clearance cut edge and interposed between the clearance cut and the grooved (recessed) pole seating top surface.

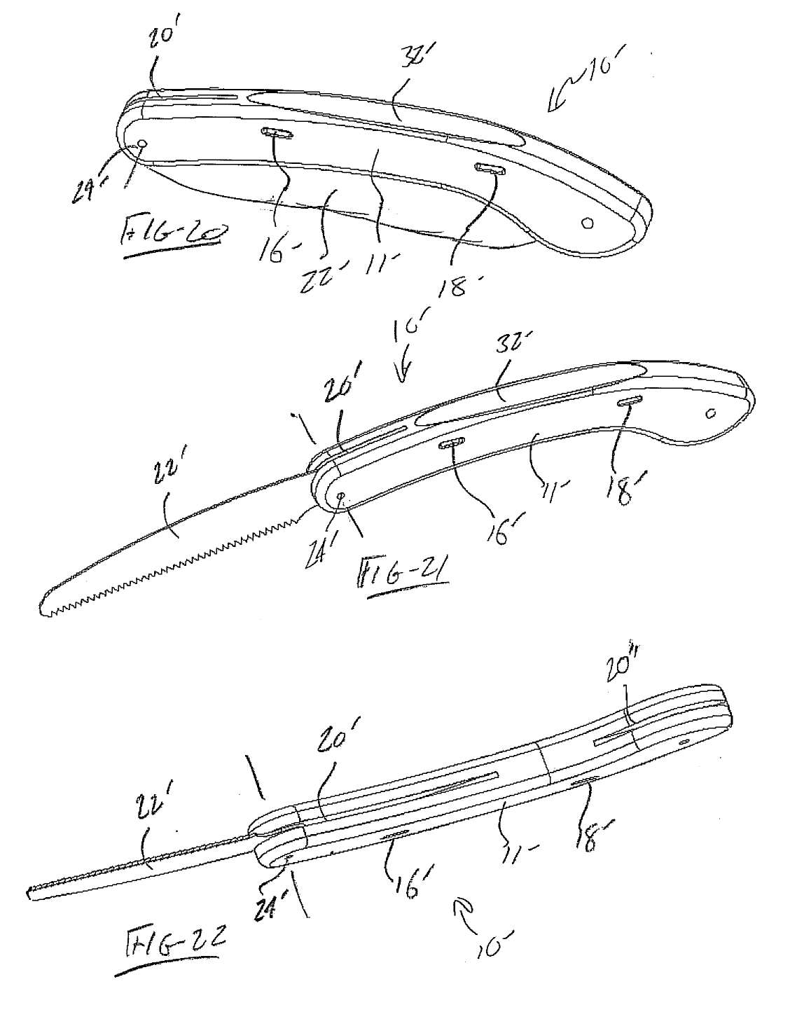

FIG. 20 is a closed perspective of the pruning saw of FIG. 14, whereas FIG. 21 is an illustration similar to FIG. 14 of the pruning saw in an open position and disengaged from a tree branch or rod. Finally, FIG. 22 is a rotated and underside looking perspective blade receiving cavity configuration relative to the positioning and arrangement of the strap receiving and crosswise extending slots. Further shown in FIG. 22 are first and second linear extending and spaced apart blade receiving slots, at 20′ and 20″ and which in further cooperation with the configuration of the handle, seats the blade 22′ when the same is rotated closed.

Given the above description, the novel aspects associated with the hand-held pruning saw again include:
1) straps that are used to secure the saw handle to a branch or pole;
2) a recessed groove on the mating side of the saw handle which allows the branch to seat more securely;
3) gripping teeth or rubberized coating included on the mating side of the handle which allows the branch or pole to seat more securely to the handle of the saw;
4) employing the recessed groove and gripper teeth or rubberized coating on the attachment side of the handle, thus allowing for various size branches or poles to be used;
5) integrating the slots into the saw handle to facilitate securing the attachment straps to the saw; and
6) designing the saw to be lightweight and compact, allowing ease of stowing, similar to a standard foldable pruning saw.

Having described my invention, other and additional preferred embodiments will become apparent to those skilled in the art to which it pertains and without deviating from the scope of the appended claims.

I claim:

1. A hand-held pruning saw, comprising:
an elongated body incorporating a blade displaceable between a first open position and a second closed position relative to said body;
said body further comprising a longitudinally extending surface which defines a depression against which is seated an extending rod; and
said body further comprising at least one crosswise extending location adapted for receiving a strap in turn securing about the rod and affixing said body thereto.

2. The saw as described in claim 1, said crosswise extending location further comprising a pair of crosswise extending slots for receiving and locating first and second straps.

3. The saw as described in claim 2, said straps each further comprising an elongated body terminating in a ring, a first surface of said body exhibiting a hook and loop fastening material, a second opposite surface of said body further exhibiting a rubberized and slip retardant layer contacting the rod.

4. The saw as described in claim 1, said seating depression further comprising an arcuate recess groove defined in a longitudinal extending direction of said body and such as to allow an opposing surface of the rod to seat against and said body.

5. The saw as described in claim 2, further comprising a linear recess terminating in an inner extending clearance cut associated with said body and against which said blade is seated in a closed position.

6. The saw as described in claim 5, further comprising each of said crosswise extending slots being defined at first and second linearly spaced and widthwise extending locations through said body, said crosswise extending slots being located between said seating depression surface and said inner extending and blade receiving clearance cut.

7. The saw as described in claim 5, further comprising a pivot mounting location established between said blade and said body and for pivoting the blade between said open and closed positions.

8. The saw as described in claim 1, said body exhibiting a specified shape and size and further comprising a plasticized construction.

9. The saw as described in claim 1, said body exhibiting a specified shape and size and further comprising a wooden construction.

10. The saw as described in claim 1, said blade exhibiting a specified shape and size and further exhibiting a serrated edge.

11. A hand-held pruning saw, comprising:
an elongated body incorporating a blade displaceable between a first open position and a second closed position relative to said body;
said body further comprising a longitudinally extending surface which defines a depression against which is seated an extending rod, said seating depression further comprising an arcuate recess groove defined in a longitudinal extending direction of said body and such as to allow an opposing surface of the rod to seat against and said body; and
said body further comprising at least one crosswise extending location adapted for receiving a strap in turn securing about the rod and affixing said body thereto, said crosswise extending location further comprising a pair of crosswise extending slots for receiving and locating first and second straps.

12. The saw as described in claim 11, said straps each further comprising an elongated body terminating in a ring, a first surface of said body exhibiting a hook and loop fastening material, a second opposite surface of said body further exhibiting a rubberized and slip retardant layer contacting the rod for providing ergonomic comfort when holding the saw and for assisting in holding a pole/branch in place when said saw is strapped thereto.

13. The saw as described in claim 11, further comprising a linear recess terminating in an inner extending clearance cut associated with said body and against which said blade is seated in a closed position.

14. The saw as described in claim 13, further comprising each of said crosswise extending slots being defined at first and second linearly spaced and widthwise extending locations through said body, said crosswise extending slots being located between said seating depression surface and said inner extending and blade receiving clearance cut.

15. The saw as described in claim 14, further comprising a pivot mounting location established between said blade and said body and for pivoting the blade between said open and closed positions.

16. The saw as described in claim 11, said body exhibiting a specified shape and size and further comprising a plasticized construction.

17. The saw as described in claim 11, said body exhibiting a specified shape and size and further comprising a wooden construction.

18. The saw as described in claim 11, said blade exhibiting a specified shape and size and further exhibiting a serrated edge.
